(19) United States
(12) Patent Application Publication
(10) Pub. No.: US 2010/0026486 A1
(43) Pub. Date: Feb. 4, 2010

(54) DIGITAL PHOTO FRAME CAPABLE OF ATTRACTING ATTENTION

(75) Inventors: SHIN-HONG CHUNG, Tu-Cheng (TW); XIAO-GUANG LI, Shenzhen City (CN); HAN-CHE WANG, Tu-Cheng (TW); FEN LI, Shenzhen City (CN); KUAN-HONG HSIEH, Tu-Cheng (TW); DUO LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/475,581

(22) Filed: May 31, 2009

(30) Foreign Application Priority Data
Aug. 1, 2008 (CN) 200820301683.4

(51) Int. Cl. G08B 21/22

(52) U.S. Cl. 340/540

(57) ABSTRACT

A digital photo frame (DPF) capable of attracting attention is provided. The DPF includes a light-emitting diode (LED) unit, a display control unit, a motion detector, and a processing unit. The processing unit is connected to the motion detector and the display control unit, and the display control unit is connected to the LED unit. If the motion detector detects there is someone around the DPF, the processing unit transmits a control signal to the display control unit, and the display control unit control the LED unit to flash in response to the control signal.

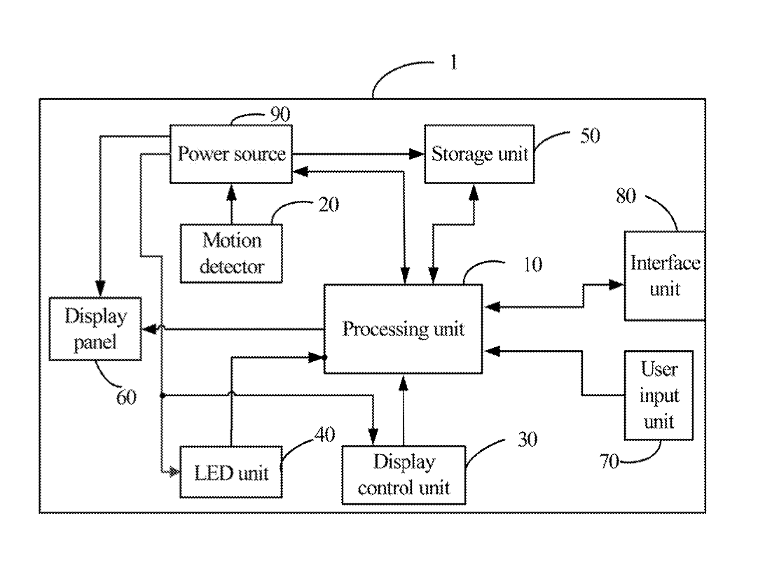

### BACKGROUND

1. Related Applications

This application is related to copending applications entitled, “DIGITAL PHOTO FRAME CAPABLE OF AUTOMATICALLY CHANGING DISPLAY MODE”, filed ______ (Atty. Docket No. US 21363); “INTELLIGENT DIGITAL PHOTO FRAME”, filed ______ (Atty. Docket No. US21364); “DIGITAL PHOTO FRAME WITH BATTERY INDICATOR” filed ______ (Atty. Docket No. US21365); and “DIGITAL PHOTO FRAME CAPABLE OF ATTRACTING ATTENTION”, filed ______ (Atty. Docket No. US22333).

2. Technical Field

The disclosure relates to electronic devices and, particularly, to a digital photo frame.

3. Description of Related Art

Nowadays, digital photos are getting more and more popular while digital cameras are becoming more and more affordable. Accordingly, in order to display digital photos, digital photo frames (DPFs) are invented.

Like the traditional photo frames, many DPFs can be either placed on a table or mounted on a wall. However, when people enter a room with a DPF, if they pay no attention to the DPF, the display of the DPF is ineffective.

Therefore, it is necessary to provide an electronic device and a method to overcome the above-identified deficiency.

### BRIEF DESCRIPTION OF THE DRAWINGS

The components in the drawing are not necessarily drawn to scale, the emphasis instead being placed upon clearly illustrating the principles of the digital photo frame.

The drawing is a block diagram of a digital photo frame in accordance with an exemplary embodiment.

### DETAILED DESCRIPTION

Referring to the drawing, a digital photo frame (DPF) 1 includes a processing unit 10, a motion detector 20, a display control unit 30, a light-emitting diode (LED) unit 40, a storage unit 50, a display panel 60, a user input unit 70, an interface unit 80 (e.g., an input port or wireless transceiver), and a power source 90. The DPF 1 is capable of automatically providing a prompt upon sensing a person in an area around the DPF 1.

The interface unit 80 is configured to connect to an external electronic device (not shown). The external device can be a storage card (e.g., a secure digital SD card, a compact flash CF card) or another electronic device (e.g., a digital camera, a mobile phone, or a computer).

The user input unit 70 is configured to generate instructions in response to user operations. The user input unit 70 can be input keys/buttons, knobs, and the like. The power source 90 is configured to provide power to elements of the DPF 1, such as the processing unit 10, the motion detector 20, the light detector 30, and the display panel 50. The power source 90 can be a battery or an AC/DC (alternating current to direct current) module.

The storage unit 50 is configured to store displayable media such as digital pictures. The display panel 60 is configured to display the media.

The motion detector 20, connected to the processing unit 10, is configured for detecting whether there is someone around the DPF 1 within a predetermined area, and producing a trigger signal to the processing unit 10 when there is. The processing unit 10 is configured to produce a control signal when receiving the trigger signal. The display control unit 30 is also connected to the processing unit 10, and is configured to control the LED unit 40 to flash when receiving the control signal. In the embodiment, if the display control unit 30 determines that the LED unit 40 has flashed for a predetermined time period, the display control unit 30 controls the LED unit 40 to stop flashing, and remain off until to be controlled to flash again, thus saving power.

The motion detector 20 may include any one or more of the following, an infrared detector, a sonar detector, an audio detector, or the like, which can work singly or in combination according to preset parameters to generate a signal when it is likely that one or more persons are present in the predetermined area.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) comprising:
a light-emitting diode (LED) unit which comprises at least one LED;
a motion detector configured for detecting whether there is someone around the DPF and producing a trigger signal when it detects that someone is around the DPF;
a processing unit configured for producing a control signal when receiving the trigger signal; and
a display control unit configured for controlling the LED unit to flash when receiving the control signal.

2. The DPF of claim 1, wherein the display control unit controls the LED unit 40 to stop flashing when it determines that the LED unit has flashed for a predetermined time period.

3. The DPF of claim 1, wherein the motion detector comprises one selected from the group consisting of an infrared detector, a sonar detector, and an audio detector.

4. The DPF of claim 1, wherein the motion detector comprises two or more detectors selected from the group consisting of an infrared detector, a sonar detector, and an audio detector; the detectors can work singly or in combination according to preset parameters to generate a signal when it is likely that one or more persons are present in the predetermined area.

5. A method of a digital photo frame (DPF), the DPF comprising:
a light-emitting diode (LED) unit;
a motion detector;
a processing unit; and
a display control unit;
the method comprising:
detecting whether there is someone around the DPF via the motion detector;
producing a trigger signal when the motion detector detects there is someone around the DPF;
producing a control signal when the processing unit receives the trigger signal; and
controlling the LED unit to flash when the display control unit receives the control signal.

6. The method of claim 5, further comprising:
controlling the LED unit to stop flash if the display control unit determines the LED unit has flashed for a predetermined time period.
